(19) United States
(12) Patent Application Publication
(10) Pub. No.: US 2025/0385038 A1
(43) Pub. Date: Dec. 18, 2025

(54) INDUCTOR AND INDUCTOR MANUFACTURING METHOD

(71) Applicant: HENGDIAN GROUP DMEGC MAGNETICS CO., LTD, Dongyang Jinhua, Zhejiang (CN)

(72) Inventors: Shengqi CHEN, Dongyang Jinhua, Zhejiang (CN); Zhihong JIN, Dongyang Jinhua, Zhejiang (CN); Linke WANG, Dongyang Jinhua, Zhejiang (CN); Jun XU, Dongyang Jinhua, Zhejiang (CN)

(21) Appl. No.: 18/878,622

(22) PCT Filed: Nov. 4, 2022
(86) PCT No.: PCT/CN2022/129860

§ 371 Date: Dec. 23, 2024

(30) Foreign Application Priority Data
Jun. 29, 2022 (CN) 202210756926.8

(51) Int. Cl. H01F 27/29; H01F 17/04; H01F 41/10

(52) U.S. Cl. CPC H01F 27/292; H01F 17/04; H01F 41/10

(57) ABSTRACT

An inductor mainly includes a magnet, two terminals, and an inductance coil, where a magnet center column is disposed in the magnet, and the inductance coil is wound around the magnet center column, and the two terminals are disposed opposite to each other on two sides of the magnet, two welding joint leads are extended from the inductance coil toward the outside of the magnet, the two welding joint leads are in one-to-one correspondence with the two terminals, and a welding joint lead is welded on a terminal.

This application claims priority to Chinese Patent Application No. 202210756926.8 filed with the China National Intellectual Property Administration (CNIPA) on Jun. 29, 2022, the disclosure of which is incorporated herein by reference in its entirety.

### TECHNICAL FIELD

The present application relates to the field of inductance technology, for example, an inductor and an inductor manufacturing method.

### BACKGROUND

Inductors are one of fundamental elements of electronic circuits and are broadly applied within electronic circuits. In an alternating current circuit, an inductor serves the functions of “passing direct current and blocking alternating current”. Consequently, the inductor can act as a current blocker, voltage reducer, coupler, and load in the circuit. Hence, inductors are widely used in industries like automobiles, home appliances, and the Internet.

At present, the manufacture of an inductor involves winding an inductance wire to a certain inner diameter and a certain number of turns to form an inductance coil, then welding the inductance coil to a terminal inside a magnet, and then bending an outer terminal to the magnet's bottom to implement current conduction. Due to the placement of the weld within the magnet in inductor design methods of the related art, it is prone to a short circuit between the weld and the inductance coil. It also limits the design dimension of the inductance coil's outer diameter, reducing the inductor's inductance amount and affecting product performance.

### SUMMARY

In a first aspect, the present application provides an inductor including a magnet and two terminals.

A magnet center column is disposed in the magnet, and an inductance coil is wound around the magnet center column.

The two terminals are disposed opposite to each other on two sides of the magnet, two welding joint leads are extended from the inductance coil toward an outside of the magnet, the two welding joint leads are in one-to-one correspondence with the two terminals, and each of the two welding joint leads is welded on a respective one of the two terminals.

In a second aspect, the present application provides an inductor manufacturing method. The method is used for processing and manufacturing the inductor in the preceding embodiment and includes the steps described below.

Alloy powder is coated with glue for granulation so that a powdery material is formed.

A copper wire is wound to form an inductance coil, where the copper wire has a round shape or a flat shape, and a coil center column has a round shape, an elliptical shape, or a racetrack shape.

Two welding joint leads extended from the inductance coil are welded on terminals through spot welding or laser welding.

The welded inductance coil is placed into a molding die, and the powdery material is added and press-molded to form a magnet encasing the inductance coil.

The formed magnet is heated, cured, and baked so that the magnet has strength.

A bent portion of a terminal is bent toward a lower end face of the magnet, where after the bent portion is bent, the bending portion abuts against the lower end face of the magnet to form an electrode used for the inductor to be surface mounted.

### BRIEF DESCRIPTION OF DRAWINGS

FIG. 1 is a structural diagram of an inductor according to embodiment one of the present application;

FIG. 2 is a structural diagram of an inductor according to embodiment two of the present application; and

FIG. 3 is a structural diagram of an inductor according to embodiment three of the present application.

### REFERENCE LIST

100 magnet
110 magnet center column
200 inductance coil
210 welding joint lead
300 terminal
310 pin portion
3101 perforation
320 connecting portion

### DETAILED DESCRIPTION

In the description of the present application, terms “joined”, “connected”, and “fixed” are to be understood in a broad sense unless otherwise expressly specified and limited. For example, the term “connected” may refer to “fixedly connected”, “detachably connected”, or integrated, may refer to “mechanically connected” or “electrically connected”, or may refer to “connected directly”, “connected indirectly through an intermediary”, “connected inside two components”, or “interaction relations between two components”. For those of ordinary skill in the art, specific meanings of the preceding terms in the present application may be understood based on specific situations.

In the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature or the first feature is obliquely on, above, or over the second feature, or the first feature is simply at a higher level than the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

In the description of embodiments, orientations or position relations indicated by terms such as “upper”, “lower”, “left”, and “right” are based on the drawings. These orientations or position relations are intended only to facilitate the description and simplify an operation and not to indicate or imply that a device or element referred to must have such particular orientations or must be configured or operated in such particular orientations. Thus, these orientations or position relations are not to be construed as limiting the present application. In addition, a feature defined as a “first” feature or a “second” feature may explicitly or implicitly include one or more of such features, which are used for distinguishing and describing the features, and there is no order or importance. In the description of the present application, unless otherwise noted, the term “multiple” means two or more.

The embodiments of the present application provide an inductor with a simple structure, which can prevent the short circuit between a weld and an inductance coil, increase the outer diameter of the inductance coil, and improve the electrical performance of the inductor.

### Embodiment One

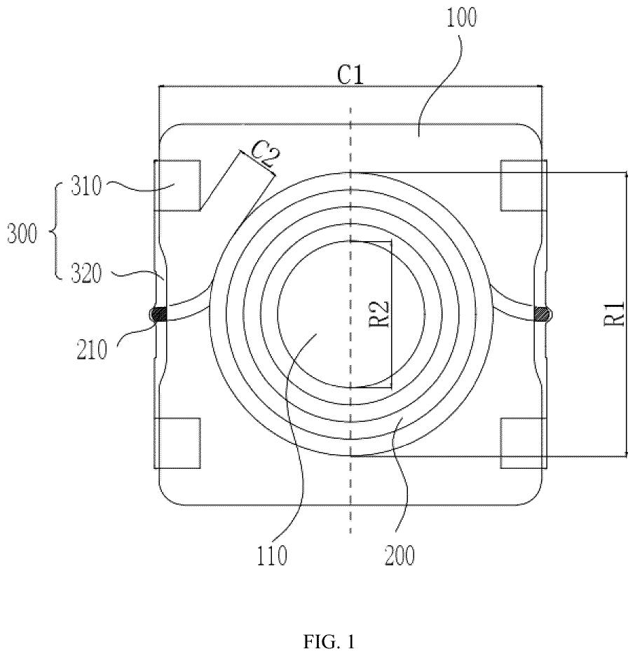

As shown in FIG. 1, this embodiment provides an inductor mainly including a magnet 100, two terminals 300, and an inductance coil 200. A magnet center column 110 is disposed in the magnet 100, and the inductance coil 200 is wound around the magnet center column 110. The two terminals 300 are disposed opposite to each other on two sides of the magnet 100, two welding joint leads 210 are extended from the inductance coil 200 toward the outside of the magnet 100, the two welding joint leads 210 are in one-to-one correspondence with the two terminals 300, and a welding joint lead 210 is welded on a terminal 300.

Based on the preceding design, a copper wire is wound to form the inductance coil 200 in this embodiment, where the copper wire has a round shape or a flat shape, and a coil center column has a round shape, an elliptical shape, or a racetrack shape. Copper wires and magnet center columns 110 of different shapes may be selected according to actual requirements, which is not limited in this embodiment. When the inductor is processed and manufactured, the copper wire is first wound to form the inductance coil 200, then the two welding joint leads 210 are led out, the two welding joint leads 210 are separately welded with the two terminals 300 through spot welding or laser welding, then the terminals 300 and the inductance coil 200 are placed into a die, and a magnetic powdery material is cast in the die and press-molded to form the magnet 100 encasing the inductance coil 200. Portions where the welding joint leads 210 are welded with the terminals 300 need to be exposed outside the die so that the magnet 100 is prevented from encasing and covering the welding joint leads 210. The magnet 100 is then baked and cured to achieve certain strength.

In an example, the terminal 300 in this embodiment is made of copper, and the surface of the copper is coated with a metal tin layer. The terminal 300 may be made of other metals, such as metal iron, metal aluminum, or another alloy, according to the actual requirements. In this embodiment, the details are not repeated one by one here.

In an example, the terminals 300 in this embodiment are disposed opposite to each other on sidewalls of the magnet 100. The positions of the terminals 300 can be flexibly configured according to the shape of the magnet 100. For example, the magnet 100 has a pentagonal shape, a hexagonal shape, or an irregular shape, and the terminals 300 may be disposed on two adjacent or non-adjacent sidewalls of the magnet 100. As long as it can be ensured that the design solution that the welded portions of the welding joint leads 210 are led out to the terminals 300 outside the magnet 100 falls within the scope of the present application, which is not limited in this embodiment.

Compared with the related art, the inductor provided by this embodiment has a simple structure, where the welding joint leads 210 are led out to the outside of the magnet 100 and welded with the terminals 300 outside the magnet 100. In this manner, the following case in the related art is avoided: the welding joint leads 210 occupy the interior space of the magnet 100 because the welding joint leads 210 are located in the magnet 100. Thus, in the magnet 100 of the same volume, the outer diameter of the inductance coil 200 is increased, thereby increasing the amount of inductance of the inductor and improving the electrical performance of the inductor. In addition, the outside positioning of the welding joint leads 210 prevents the risk of a short circuit between the inductance coil 200 and the welding joint leads 210 when the inductor is in operation, thereby enhancing the safety performance of the inductor.

As shown in FIG. 1, in this embodiment, the terminal 300 includes a pin portion 310 and a connecting portion 320 integrally formed with the pin portion 310, the pin portion 310 after being bent is embedded in the magnet 100, and the connecting portion 320 is attached to a sidewall of the magnet 100. The welding joint lead 210 is welded on the connecting portion 320. Optionally, in this embodiment, two pin portions 310 are disposed on each terminal 300, and a total of four pin portions 310 are disposed on the two terminals 300. The pin portion 310 in FIG. 1 is not attached to the upper end face of the magnet 100, but the pin portion 310 is embedded in the magnet 100 in the process where the magnetic powdery material is processed and cast. FIG. 1 is a schematic view only showing the relative position of the pin portion 310 and the relative position of the inductance coil 200.

In an example, the terminal 300 in this embodiment includes a bent portion (not shown in the figure) which is disposed at the end of the connecting portion 320 facing away from the pin portion 310 and is integrally formed with the connecting portion 320, where after the bent portion is bent, the bending portion abuts against the lower end face of the magnet 100 to form an electrode, and the electrode is used for the inductor to be surface mounted. Thus, the connection between the inductor and a circuit board is facilitated.

For example, in this embodiment, each terminal 300 is extended with one bent portion, and the bent portion is placed outside the die during the process of processing and casting the magnetic powdery material. This placement facilitates bending the bent portion toward the lower end face of the magnet 100 in the subsequent procedure to form the electrode that facilitates subsequent surface mounting on the electrode. In addition, in this embodiment, the sum of the widths of two bent portions is less than a side length of the magnet 100, preventing a short-circuit fault caused by the connection of two electrodes.

As shown in FIG. 1, the upper end face of the magnet 100 in this embodiment is a square, where a side length of the square is C1, the minimum distance from the outer diameter of the inductance coil 200 to the pin portion 310 is C2, and C1 and C2 satisfy the relationship 9.0≤C1/C2≤10.0. For example, the inductance coil 200 in this embodiment is designed with an outer diameter R1 of 5.8 mm, the side length C1 of the magnet 100 is 7.8 mm, and the minimum distance C2 from the outer diameter of the inductance coil 200 to the pin portion 310 is 0.85 mm. Under the same condition, C2 in the related art can only be set to 0.39 mm, and C2 in this embodiment is 0.46 mm larger than that in the related art. The height of the magnet 100 is 5.2 mm, the height of the inductance coil 200 is 0.35*9=3.15 mm, and the diameter R2 of the magnet center column 110 is 3 mm. When the inductor in this embodiment is applied to the design of an inductor with high inductance, the failure risk of a high inductance waveform can be greatly reduced. When the inductor in this embodiment is applied to the design of a consumer induction with low inductance, it can be satisfied that the spacing between the inductance coil 200 and the terminal 300 is unchanged, and the inner diameter of the magnet center column 110 is increased so that an overall inductance characteristic is improved.

In an embodiment, the magnet center column 110 may be part of the magnet 100. The magnet center column 110 may be disposed separately, or the magnet 100 including the magnet center column 110 may be directly pressed and formed at the time of molding.

This embodiment further provides an inductor manufacturing method. The method is used for processing and manufacturing the inductor in the preceding embodiment and includes the steps described below.

Preparing a powdery material: alloy powder is coated with glue for granulation so that the powdery material is formed.

For example, the alloy powder is a non-corrosion-resistant magnetic material, and the step of preparing the powdery material includes performing coating insulation on the non-corrosion-resistant magnetic material. Alternatively, corrosion-resistant magnetic material alloy powder could be used, thus eliminating the need for the coating insulation process and improving processing and manufacturing steps. In addition, one of carbonyl iron powder, amorphous powder, nanocrystalline powder, or the like, or any combination thereof may be added to the powdery material. The magnetic permeability of the powdery material is controlled between 10 and 60, and the mesh number of the powdery material granulated with the glue is between 60 meshes and 300 meshes. However, to improve the fluidity of the powdery material, it is necessary to ensure that the number of granules below 300 meshes accounts for less than 10% of the total.

Preparing the inductance coil 200: the copper wire is wound to form the inductance coil 200, where the copper wire has the round shape or the flat shape, and the coil center column has the round shape, the elliptical shape, or the racetrack shape, and the outer diameter of the inductance coil 200 is C1.

Welding: the two welding joint leads 210 extended from the inductance coil 200 are welded on the terminals 300 through the spot welding or the laser welding. For example, the welding joint lead 210 is welded on the connecting portion 320 of the terminal 300.

Molding: the welded inductance coil 200 is placed into a molding die, and the powdery material is added and press-molded to form the magnet 100 encasing the inductance coil 200.

For example, when the inductance coil 200 is placed into the molding die, it is necessary to ensure that the position where the welding joint lead 210 is welded with the connecting portion 320 is outside the die, thereby ensuring that the inductance coil 200 of a larger outer diameter can be accommodated in the magnet 100 with a space having a limited volume.

Baking: the formed magnet 100 is heated, cured, and baked so that the magnet 100 has certain strength, thereby prolonging the service life of the magnet 100. An operator may flexibly set baking time and a baking temperature according to actual conditions, for example, the baking time is between 30 minutes and 60 minutes, and the baking temperature is between 200 degrees Celsius and −500 degrees Celsius, which are not limited in this embodiment.

Bending: the bent portion of the terminal 300 is bent toward the lower end face of the magnet 100, where after the bent portion is bent, the bent portion abuts against the lower end face of the magnet 100 to form the electrode used for the inductor to be surface mounted. Thus, the connection between the inductor and the circuit board is facilitated.

With the inductor manufacturing method in this embodiment, not only an inductor of 8 mm*8 mm but also inductors of the series of 2 mm*2 mm to 32 mm*32 mm can be manufactured. For example, with the inductor manufacturing method, inductors of 2 mm*2 mm, 5 mm*5 mm, 10 mm*10 mm, and 32 mm*32 mm can be manufactured, and in this embodiment, the details are not repeated one by one.

Steps of the inductor manufacturing method in this embodiment are simple for easier processing and operation so that an inductor with a large amount of inductance can be processed and manufactured, the electrical performance of the inductor is improved, and the cost is saved.

### Embodiment Two

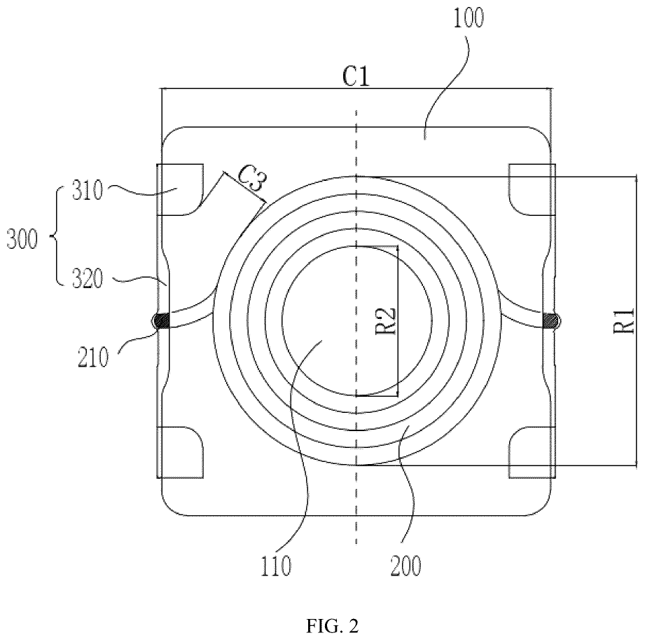

As shown in FIG. 2, this embodiment provides an inductor, which is mainly different from embodiment one in that a chamfer is disposed at the end of the pin portion 310 in this embodiment facing the inductance coil 200, and the upper end face of the magnet 100 is the square, where the side length of the square is C1, the minimum distance from the outer diameter of the inductance coil 200 to the chamfer is C3, and C1 and C3 satisfy the relationship 8.0≤C1/C3≤9.0. The decrease in the ratio of C1/C3 means that in the magnet 100 of the same volume, the distance between the inductance coil 200 and the pin portion 310 is increased, thereby increasing the amount of inductance of the inductor and improving product performance. For example, the inductance coil 200 in this embodiment is designed to have an outer diameter R1 of 5.8 mm, the side length C1 of the magnet 100 is 7.8 mm, and the minimum distance C2 from the outer diameter of the inductance coil 200 to the pin portion 310 is 1.05 mm. Under the same condition, C2 in the related art can only be set to 0.39 mm, and C2 in this embodiment is 0.66 mm larger than that in the related art. The height of the magnet 100 is 5.2 mm, the height of the inductance coil 200 is 0.35*9=3.15 mm, and the diameter R2 of the magnet center column 100 is 3 mm.

The remaining structures in this embodiment are the same as those in embodiment one, and the details are not repeated one by one here.

This embodiment further provides an inductor manufacturing method. The method is used for processing and manufacturing the inductor in the preceding embodiment and includes the steps described below.

Preparing the powdery material: the alloy powder is coated with the glue for the granulation so that the powdery material is formed.

For example, the alloy powder is the non-corrosion-resistant magnetic material, and the step of preparing the powdery material includes performing the coating insulation on the non-corrosion-resistant magnetic material. The alloy powder which is the corrosion-resistant magnetic material may be adopted so that the coating insulation of the alloy powder is not required and the processing and manufacturing steps are improved. In addition, one of the carbonyl iron powder, the amorphous powder, the nanocrystalline powder, or the like, or any combination thereof may be added to the powdery material. The magnetic permeability of the powdery material is controlled between 10 and 60, and the mesh number of the powdery material granulated with the glue is between 60 meshes and 300 meshes. However, to improve the fluidity of the powdery material, it is necessary to ensure that the proportion of granules below 300 meshes is lower than 10%.

Preparing the inductance coil 200: the copper wire is wound to form the inductance coil 200, where the copper wire has the round shape or the flat shape, and the coil center column has the round shape, the elliptical shape, or the racetrack shape, and the outer diameter of the inductance coil 200 is C1.

Welding: the two welding joint leads 210 extended from the inductance coil 200 are welded on the terminals 300 through the spot welding or the laser welding. For example, the welding joint lead 210 is welded on the connecting portion 320 of the terminal 300.

Molding: the welded inductance coil 200 is placed into the molding die, and the powdery material is added and press-molded to form the magnet 100 encasing the inductance coil 200.

For example, when the inductance coil 200 is placed into the molding die, it is necessary to ensure that the position where the welding joint lead 210 is welded with the connecting portion 320 is outside the die, thereby ensuring that the inductance coil 200 of the larger outer diameter can be accommodated in the magnet 100 with the space having the limited volume.

Baking: the formed magnet 100 is heated, cured, and baked so that the magnet 100 has certain strength, thereby prolonging the service life of the magnet 100. The operator may flexibly set the baking time and the baking temperature according to the actual conditions, for example, the baking time is between 30 minutes and 60 minutes, and the baking temperature is between 200 degrees Celsius and 500 degrees Celsius, which are not limited in this embodiment.

Bending: the bent portion of the terminal 300 is bent toward the lower end face of the magnet 100, where after the bent portion is bent, the bending portion abuts against the lower end face of the magnet 100 to form the electrode used for the inductor to be surface mounted. Thus, the connection between the inductor and the circuit board is facilitated.

With the inductor manufacturing method in this embodiment, not only the inductor of 8 mm*8 mm but also the inductors of the series of 2 mm*2 mm to 32 mm*32 mm can be manufactured. For example, with the inductor manufacturing method, the inductors of 2 mm*2 mm, 5 mm*5 mm, 10 mm*10 mm, and 32 mm*32 mm can be manufactured, and in this embodiment, the details are not repeated one by one.

Steps of the inductor manufacturing method in this embodiment are simple for the easier processing and operation so that the inductor with a large amount of inductance can be processed and manufactured, the electrical performance of the inductor is improved, and the cost is saved.

### Embodiment Three

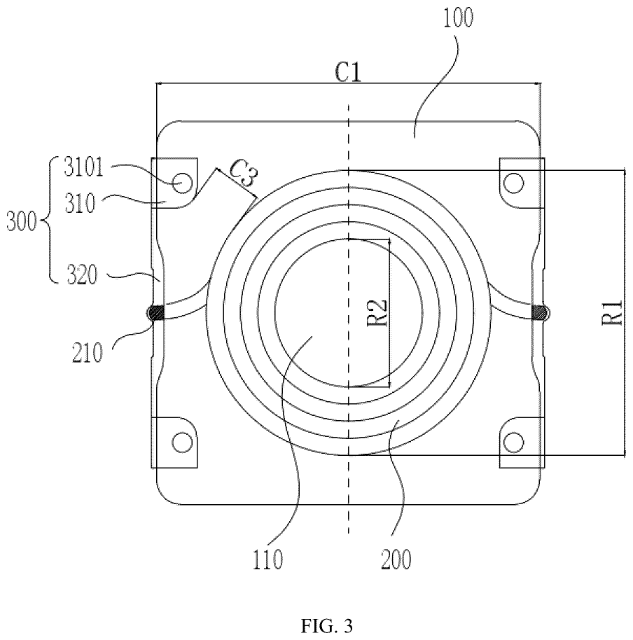

As shown in FIG. 3, this embodiment provides an inductor, which is mainly different from embodiment two in that a perforation 3101 is disposed on the pin portion 310 in this embodiment. For example, perforations 3101 are disposed on the four pin portions 310 on the two terminals 300. The perforations 3101 are provided so that in the procedure where the magnet 100 is molded, the powdery material can pass through the perforations 3101, and after the magnet 100 is cured and baked, the gripping capability and bonding force between the terminals 300 and the magnet 100 are improved, thereby improving the reliability and stability of the terminals 300.

For example, the perforations 3101 in this embodiment may be configured to be round, square, elliptical, or irregular. One or more perforations 3101 may be disposed on each pin portion 310, for example, the number of perforations 3101 may be set to one, two, three, or the like, which is not limited in this embodiment.

For example, the upper end face of the magnet 100 is the square, where the side length of the square is C1, the minimum distance from the outer diameter of the inductance coil 200 to the chamfer is C3, and C1 and C3 satisfy the relationship 8.0≤C1/C3≤9.0. The decrease in the ratio of C1/C3 means that in the magnet 100 of the same volume, the distance between the inductance coil 200 and the pin portion 310 is increased, thereby increasing the amount of inductance of the inductor and improving product performance. For example, the inductance coil 200 in this embodiment is designed to have an outer diameter R1 of 5.8 mm, the side length C1 of the magnet 100 is 7.8 mm, and the minimum distance C2 from the outer diameter of the inductance coil 200 to the pin portion 310 is 1.05 mm. Under the same condition, C2 in the related art can only be set to 0.39 mm, and C2 in this embodiment is 0.66 mm larger than that in the related art. The height of the magnet 100 is 5.2 mm, the height of the inductance coil 200 is 0.35*9=3.15 mm, and the diameter R2 of the magnet center column 110 is 3 mm.

The remaining structures in this embodiment are the same as those in embodiment two, and the details are not repeated one by one here.

This embodiment further provides an inductor manufacturing method. The method is used for processing and manufacturing the inductor in the preceding embodiment and includes the steps described below.

Preparing the powdery material: the alloy powder is coated with the glue for the granulation so that the powdery material is formed.

For example, the alloy powder is the non-corrosion-resistant magnetic material, and the step of preparing the powdery material includes performing the coating insulation on the non-corrosion-resistant magnetic material. Of course, the operator may adopt the alloy powder which is the corrosion-resistant magnetic material so that the coating insulation of the alloy powder is not required and the processing and manufacturing steps are improved. In addition, one of the carbonyl iron powder, the amorphous powder, the nanocrystalline powder, or the like, or any combination thereof may be added to the powdery material. The magnetic permeability of the powdery material is controlled between 10 and 60, and the mesh number of the powdery material granulated with the glue is between 60 meshes and 300 meshes. However, to improve the fluidity of the powdery material, it is necessary to ensure that the proportion of granules below 300 meshes is lower than 10%.

Preparing the inductance coil 200: the copper wire is wound to form the inductance coil 200, where the copper wire has the round shape or the flat shape, and the coil center column has the round shape, the elliptical shape, or the racetrack shape, and the outer diameter of the inductance coil 200 is C1.

Welding: the two welding joint leads 210 extended from the inductance coil 200 are welded on the terminals 300 through the spot welding or the laser welding. For example, the welding joint lead 210 is welded on the connecting portion 320 of the terminal 300.

Molding: the welded inductance coil 200 is placed into the molding die, and the powdery material is added and press-molded to form the magnet 100 encasing the inductance coil 200.

For example, when the inductance coil 200 is placed into the molding die, it is necessary to ensure that the position where the welding joint lead 210 is welded with the connecting portion 320 is outside the die, thereby ensuring that the inductance coil 200 of the larger outer diameter can be accommodated in the magnet 100 with the space having the limited volume.

Baking: the formed magnet 100 is heated, cured, and baked so that the magnet 100 has certain strength, thereby prolonging the service life of the magnet 100. The operator may flexibly set the baking time and the baking temperature according to the actual conditions, for example, the baking time is between 30 minutes and 60 minutes, and the baking temperature is between 200 degrees Celsius and −500 degrees Celsius, which are not limited in this embodiment.

Bending: the bent portion of the terminal 300 is bent toward the lower end face of the magnet 100, where after the bent portion is bent, the bent portion abuts against the lower end face of the magnet 100 to form the electrode, where the electrode is used for the inductor to be surface mounted. Thus, the connection between the inductor and the circuit board is facilitated.

With the inductor manufacturing method in this embodiment, not only the inductor of 8 mm*8 mm but also the inductors of the series of 2 mm*2 mm to 32 mm*32 mm can be manufactured. For example, with the inductor manufacturing method, the inductors of 2 mm*2 mm, 5 mm*5 mm, 10 mm*10 mm, and 32 mm*32 mm can be manufactured, and in this embodiment, the details are not repeated one by one.

Steps of the inductor manufacturing method in this embodiment are simple for the easier processing and operation so that the inductor with a large amount of inductance can be processed and manufactured, the electrical performance of the inductor is improved, and the cost is saved.

In summary, the following test results have been obtained through an electrical performance test of the inductors provided by the preceding three embodiments:

| Group | Related art | Embodiment one | Embodiment two | Embodiment three |
|---|---|---|---|---|
| Inductance Value | 47 | 47 | 56 | 47 |
| L/uH | | | | |
| Saturation Current | 3 | 3 | 3.2 | 3.5 |
| Isat/A | | | | |
| Direct Current | 125 | 125 | 133 | 125 |
| Resistance | | | | |
| DCR/mΩ | | | | |
| Short Circuit | 100 | 0 | / | / |
| Level ppm | | | | |
| Inductance Coil | Wire diameter | Wire diameter | Wire diameter | Wire diameter |
| | 0.3* center | 0.3* center | 0.3* center | 0.31* center |
| | column 3*35.5TS | column 3*35.5TS | column 3.45*35.5TS | column 3.35*35.5TS |

### Water Pressure Resistance Test Results for Magnets:

| Breakdown Voltage Level/0.1 mA | | |
|---|---|---|
| (milliampere) 5 S (second) | 0.4 mm | 0.8 mm |
| Max/V | 95 | 210 |
| Avg/V | 70 | 175 |
| Min/V | 60 | 140 |

It is to be understood by those skilled in the art that the present application is not limited to the embodiments described herein. For those skilled in the art, various modifications, adaptations, and substitutions can be made without departing from the scope of the present application. Therefore, while the present application is described through the preceding embodiments, the present application is not limited to the preceding embodiments and may include more other equivalent embodiments without departing from the concept of the present invention. The scope of the present application is determined by the scope of the appended claims.

In the description of the specification, the description of reference terms such as “some embodiments” and “other embodiments” is intended to mean that specific features, structures, materials, or characteristics described in conjunction with such embodiments or examples are included in at least one embodiment or example of the present application. In the specification, the illustrative description of the preceding terms does not necessarily refer to the same embodiment or example. Moreover, the described specific features, structures, materials, or characteristics may be combined in an appropriate manner in any one or more embodiments or examples. For those having ordinary skills in the art, according to the idea of the present application, there will be changes in a specific implementation manner and an application scope. The content of this specification should not be construed as limiting the present application.

What is claimed is:

1. An inductor, comprising:
a magnet, wherein a magnet center column is disposed in the magnet, and an inductance coil is wound around the magnet center column; and
two terminals, wherein the two terminals are disposed opposite to each other on two sides of the magnet, two welding joint leads are extended from the inductance coil toward an outside of the magnet, the two welding joint leads are in one-to-one correspondence with the two terminals, and each of the two welding joint leads is welded on a respective one of the two terminals.

2. The inductor according to claim 1, wherein each of the two terminals comprises a pin portion and a connecting portion integrally formed with the pin portion, the pin portion is embedded in the magnet, and the connecting portion is attached to a sidewall of the magnet.

3. The inductor according to claim 2, wherein the each of the two welding joint leads is welded on a respective connecting portion.

4. The inductor according to claim 3, wherein the each of the two welding joint leads is connected to the respective connecting portion through spot welding or laser welding.

5. The inductor according to claim 2, wherein the each of the two terminals comprises a bent portion which is disposed at an end of the connecting portion facing away from the pin portion and is integrally formed with the connecting portion, wherein after the bent portion is bent, the bent portion abuts against a lower end face of the magnet to form an electrode.

6. The inductor according to claim 2, wherein an upper end face of the magnet is a square with a side length of C1, a minimum distance from an outer diameter of the inductance coil to the pin portion is C2, and C1 and C2 satisfy a relationship 9.0≤C1/C2≤10.0.

7. The inductor according to claim 2, wherein a chamfer is disposed at an end of each pin portion facing the inductance coil, and an upper end face of the magnet is a square with a side length of C1, a minimum distance from an outer diameter of the inductance coil to the chamfer is C3, and C1 and C3 satisfy a relationship 8.0≤C1/C3≤9.0.

8. The inductor according to claim 2, wherein a perforation is disposed on each pin portion.

9. An inductor manufacturing method, the method being used for processing and manufacturing an inductor, wherein the inductor comprises:
a magnet, wherein a magnet center column is disposed in the magnet, and an inductance coil is wound around the magnet center column; and
two terminals, wherein the two terminals are disposed opposite to each other on two sides of the magnet, two welding joint leads are extended from the inductance coil toward an outside of the magnet, the two welding joint leads are in one-to-one correspondence with the two terminals, and each of the two welding joint leads is welded on a respective one of the two terminals,
wherein the inductor manufacturing method comprises:
coating alloy powder with glue for granulation to form a powdery material;
winding a copper wire to form an inductance coil, wherein the copper wire has a round shape or a flat shape, and a coil center column has a round shape, an elliptical shape, or a racetrack shape;
welding, through spot welding or laser welding, two welding joint leads extended from the inductance coil on terminals;
placing the welded inductance coil into a molding die, and adding and press-molding the powdery material to form a magnet encasing the inductance coil;
heating, curing, and baking a formed magnet to provide the magnet strength; and
bending a bent portion of each of the terminals toward a lower end face of the magnet, wherein after the bent portion is bent, the bent portion abuts against the lower end face of the magnet to form an electrode used for the inductor to be surface mounted.

10. The inductor manufacturing method according to claim 9, wherein the alloy powder is a magnetic material;
wherein coating the alloy powder with the glue for the granulation to form the powdery material comprises: performing a corrosion-resistant coating on a non-corrosion-resistant magnetic material and performing no corrosion-resistant coating on a corrosion-resistant magnetic material.

11. The inductor manufacturing method according to claim 9, wherein each of the two terminals comprises a pin portion and a connecting portion integrally formed with the pin portion, the pin portion is embedded in the magnet, and the connecting portion is attached to a sidewall of the magnet.

12. The inductor manufacturing method according to claim 11, wherein the each of the two welding joint leads is welded on a respective connecting portion.

13. The inductor manufacturing method according to claim 12, wherein the each of the two welding joint leads is connected to the respective connecting portion through spot welding or laser welding.

14. The inductor manufacturing method according to claim 11, wherein the each of the two terminals comprises a bent portion which is disposed at an end of the connecting portion facing away from the pin portion and is integrally formed with the connecting portion, wherein after the bent portion is bent, the bent portion abuts against a lower end face of the magnet to form an electrode.

15. The inductor manufacturing method according to claim 11, wherein an upper end face of the magnet is a square with a side length of C1, a minimum distance from an outer diameter of the inductance coil to the pin portion is C2, and C1 and C2 satisfy a relationship 9.0≤C1/C2≤10.0.

16. The inductor manufacturing method according to claim 11, wherein a chamfer is disposed at an end of each pin portion facing the inductance coil, and an upper end face of the magnet is a square with a side length of C1, a minimum distance from an outer diameter of the inductance coil to the chamfer is C3, and C1 and C3 satisfy a relationship 8.0≤C1/C3≤9.0.

17. The inductor manufacturing method according to claim 11, wherein a perforation is disposed on each pin portion.
